(19) United States
(12) Patent Application Publication
(10) Pub. No.: US 2021/0317686 A1
(43) Pub. Date: Oct. 14, 2021

(54) LUGGAGE LOCK

(71) Applicant: SINOX LOCK (KUNSHAN) CO., LTD., Kunshan (CN)

(72) Inventors: Changjiang YU, Kunshan (CN); Xiaodi ZHANG, Kunshan (CN)

(21) Appl. No.: 17/267,594

(22) PCT Filed: May 27, 2020
(86) PCT No.: PCT/CN2020/092483

§ 371 Date: Feb. 10, 2021

(30) Foreign Application Priority Data
May 30, 2019 (CN) 201910464885.3

(51) Int. Cl. E05B 65/52; E05B 37/02; A45C 13/10; A45C 13/18

(52) U.S. Cl. CPC E05B 65/52; A45C 13/18; A45C 13/103; E05B 37/02

(57) ABSTRACT

Provided is a luggage lock including a zipper tab and a lock body. The lock body includes a housing, a lock hook mechanism and a drive mechanism. The housing is provided with at least one lock hole capable of being in fit with the zipper tab. The lock hook mechanism is disposed in the housing and includes a snap hook assembly, the snap hook assembly is movable between a locking position and an unlocking position, the locking position is aligned with one lock hole, and the unlocking position is located outside the one lock hole. The drive mechanism is disposed in the housing and is capable of driving the snap hook assembly to move between the locking position and the unlocking position.

The present application claims priority to Chinese Patent Application No. 201910464885.3 filed on May 30, 2019, the disclosure of which is incorporated herein by reference in its entirety.

### TECHNICAL FIELD

The present application relates to the technical field of luggage accessories, for example, relates to a luggage lock.

### BACKGROUND

Luggage is an item used to hold scattered articles or belongings in people's life. Due to the rapid development of the tourism industry today, the demand for luggage is increasing. Generally, luggage is mounted with a lock. In the related art, most of the locks mounted on luggage are code locks or key locks. The code lock or the key lock cooperates with the pull tab of a zipper on the luggage to lock the luggage. When the luggage needs to be opened, the codes are toggled or a key is inserted and turned to release the pull tab.

Some luggage, which needs to go through customs, is generally mounted with customs locks. The customs lock, also known as a TSA certification lock, refers to the universal TSA dedicated key commonly used by international customs to ensure the safety of cargo during transportation when the customs conducts safety detection on trans-customs belongings or cargo or during transportation of cargo under customs supervision. For the customs lock in the related art, pull tabs are hooked by snap hooks, the number of snap hooks is two, and the two snap hooks are integrated through a linkage piece. When the customs lock needs to be unlocked, the linkage piece needs to be pulled outwards to release the snap hooks, so the pull tabs can be separated from the snap hooks. The structure is complex, and the operation is troublesome. Moreover, when the customs lock is in a locking state, the pull tabs cannot get hooked with the snap hooks, and the lock needs to be unlocked before being locked, leading to tedious operation procedures.

### SUMMARY

The present application provides a luggage lock which is convenient to operate, and a zipper tab can be inserted into a lock hole in a locking state.

One embodiment of the present application provides a luggage lock including a zipper tab and a lock body. The lock body includes a housing, a lock hook mechanism and a drive mechanism.

The housing is provided with at least one lock hole capable of being in fit with the zipper tab.

The lock hook mechanism is disposed in the housing and includes a hook assembly. The hook assembly is movable between a locking position and an unlocking position, the locking position is aligned with one of the at least one lock hole, and the unlocking position is located outside the one of the at least one lock hole.

The drive mechanism is disposed in the housing and is capable of driving the snap hook assembly to move between the locking position and the unlocking position.

The snap hook assembly is driven by the drive mechanism to move between the locking position and the unlocking position, so that the limitation that the snap hook assembly and the linkage piece are integrated is eliminated, and the snap hook assembly is independent and can move without being limited by the linkage piece. Moreover, the locking position is aligned with a lock hole, the unlocking position is located outside the lock hole, in the locking state, the zipper tab can still be inserted into the lock hole to be in fit with the snap hook assembly for locking, and the lock does not need to be unlocked before being locked, so that the operation is convenient.

In one embodiment, the snap hook assembly includes a moving seat and a snap hook.

The moving seat is in sliding fit with a bottom of the housing.

The snap hook is rotatably connected to a top of the moving seat, and the snap hook is capable of being in hooking fit with the zipper tab at the locking position and being separated from the zipper tab at the unlocking position.

The snap hook is enabled to be in hooking fit with the zipper tab at the locking position, so that the zipper tab can still be inserted into the lock hole to be in fit with the snap hook assembly for locking in the locking state without the lock being unlocked before being locked.

In one embodiment, the lock hook mechanism further includes a resilient piece capable of abutting against the zipper tab. The resilient piece abuts against the zipper tab, so that the zipper tab can be quickly ejected during unlocking, and the zipper tab can be easily separated from the lock hole.

In one embodiment, a torsion spring is connected between the snap hook and the moving seat. The snap hook can be resiliently rotated by utilizing the resilient force of the torsion spring.

In one embodiment, the moving seat is provided with a limit groove for limiting a rotation angle of the snap hook, and the snap hook is provided with a limit portion for being in sliding fit with the limit groove. The rotation angle of the snap hook is limited, so that the snap hook can be hooked with the zipper tab after being rotated a preset angle. The snap hook is also rotated the preset angle in a resetting process, so that the zipper tab is ensured to be stably hooked with the snap hook without slipping off.

In one embodiment, the bottom of the housing is provided with a limit block for limiting a movement stroke of the moving seat. The movement stroke of the moving seat is limited, so that the snap hook assembly can be ensured to move accurately between the locking position and the unlocking position.

In one embodiment, the drive mechanism includes a lock core, a lock core barrel and a drive disc.

The lock core is sleeved with the lock core barrel and coaxially connected to the drive disc, and the lock core is rotatable relative to the lock core barrel.

A connection portion is disposed eccentrically on the drive disc, and the connection portion is connected to the moving seat.

The moving seat can be driven to move simply when the lock core is rotated, so that the snap hook assembly is driven to move between the locking position and the unlocking position, and the operation is convenient.

In one embodiment, an end portion of the lock core barrel is provided with a notch for limiting a rotation angle of the lock core, and the lock core is provided with a bump for being in sliding fit with the notch. The rotation angle of the moving seat is limited, so that the snap hook assembly can be ensured to move accurately between the locking position and the unlocking position.

In one embodiment, a top of the housing is provided with a through hole for a top of the lock core to protrude through. The through hole is configured to expose the lock core, facilitating the operation of the lock core or mounting of a button on the lock core.

In one embodiment, the zipper tab is provided with a snap ring capable of hooking the snap hook. The snap ring is used to be hooked with the snap hook, and the structure is simple.

According to the luggage lock provided by the present application, the snap hook assembly is driven by the drive mechanism to move between the locking position and the unlocking position, so that the limitation that the snap hook assembly and the linkage piece are integrated is eliminated, and the snap hook assembly is independent and can move without being limited by the linkage piece. Moreover, the locking position is aligned with the lock hole, the unlocking position is located outside the lock hole, in the locking state, the zipper tab can still be inserted into the lock hole to be in fit with the snap hook assembly for locking, and the lock does not need to be unlocked before being locked, so that the operation is convenient.

### BRIEF DESCRIPTION OF DRAWINGS

FIG. 1 is a structural view of a luggage lock according to an embodiment of the present application;

FIG. 2 is an exploded view of a luggage lock according to an embodiment of the present application;

FIG. 3 is a structural view of a moving seat of a luggage lock according to an embodiment of the present application;

FIG. 4 is a structural view of a snap hook of a luggage lock according to an embodiment of the present application;

FIG. 5 is a structural view of a drive disc of a luggage lock according to an embodiment of the present application;

FIG. 6 is a structural view of a lock core barrel of a luggage lock according to an embodiment of the present application;

FIG. 7 is a structural view of a lock core of a luggage lock according to an embodiment of the present application;

FIG. 8 is a view showing a state in which a zipper tab of a luggage lock has yet been inserted into a lock body according to an embodiment of the present application;

FIG. 9 is a view showing a state in which a zipper tab of a luggage lock is being inserted into a lock body according to an embodiment of the present application;

FIG. 10 is a sectional view showing a zipper tab of a luggage lock being inserted into a lock body according to an embodiment of the present application;

FIG. 11 is a sectional view showing that a zipper tab of a luggage lock has been inserted into a lock body according to an embodiment of the present application;

FIG. 12 is a view showing a state of locking after a zipper tab of a luggage lock has been inserted into a lock body according to an embodiment of the present application;

FIG. 13 is a sectional view showing a luggage lock in an unlocking state in which a zipper tab has not yet been ejected from a lock body according to an embodiment of the present application;

FIG. 14 is a sectional view showing a luggage lock in an unlocking state in which a zipper tab is being ejected from a lock body according to an embodiment of the present application; and

FIG. 15 is a state view of a luggage lock in an unlocking state according to an embodiment of the present application.

### REFERENCE LIST

100 zipper tab

101 snap ring

200 lock body

210 housing

211 lock hole

212 limit block

213 through hole

220 lock hook mechanism

221 snap hook assembly

2211 moving seat

2212 snap hook

2213 limit groove

2214 limit portion

222 resilient piece

230 drive mechanism

231 lock core

2311 bump

232 lock core barrel

2321 notch

233 drive disc

2331 connection portion

### DETAILED DESCRIPTION

In the description of the present application, unless otherwise expressly specified and limited, the term “connected to each other”, “connected” or “secured” is to be construed in a broad sense, for example, as securely connected, detachably connected, or integrated; mechanically connected or electrically connected; directly connected to each other or indirectly connected to each other via an intermediary; or internally connected between two elements or interactional relations between two elements. For those of ordinary skill in the art, specific meanings of the preceding terms in the present application may be understood based on specific situations.

In the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

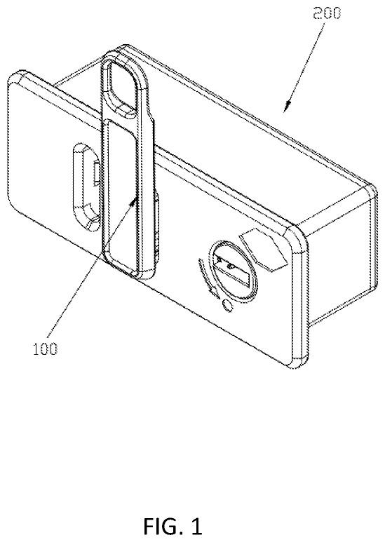

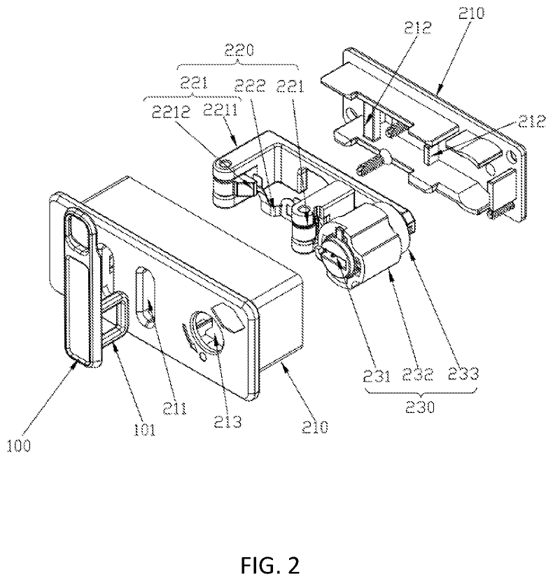

As shown in FIGS. 1 and 2, a luggage lock of the present application includes a zipper tab 100 and a lock body 200. The lock body 200 includes a housing 210, a lock hook mechanism 220 and a drive mechanism 230. The housing 210 is provided with at least one lock hole 211 capable of being in fit with the zipper tab 100. The lock hook mechanism 220 is disposed in the housing 210 and includes a snap hook assembly 221. The snap hook assembly 221 is movable between a locking position and an unlocking position, the locking position is aligned with a lock hole 211, and the unlocking position is located outside the lock hole 211. The drive mechanism 230 is disposed in the housing 210 and is capable of driving the snap hook assembly 221 to move between the locking position and the unlocking position

The housing 210 of the present application has a structure of detachable two parts, so that the assembly of the lock hook mechanism 220 and the drive mechanism 230 within the housing 210 can be facilitated. In one embodiment, the housing 210 is provided with two lock holes 211 to be suitable for the luggage with dual zipper tabs 100. Similarly, the number of snap hook assemblies 221 is two, and the two snap hook assemblies 221 are disposed opposite to each other. The drive mechanism 230 can drive the two snap hook assemblies 221 to be close to each other or far away from each other, so that the two snap hook assemblies 221 can move between their respective locking positions and unlocking positions at the same time.

In the present application, the snap hook assembly 221 is driven by the drive mechanism 230 to move between the locking position and the unlocking position, and compared with the related art, the limitation that the snap hook assembly 221 and the linkage piece are integrated is eliminated, so that the snap hook assembly is independent and can move without being limited by the linkage piece. Moreover, the locking position is aligned with the lock hole 211, the unlocking position is located outside the lock hole 211, in the locking state, the zipper tab 100 can still be inserted into the lock hole 211 to be in fit with the snap hook assembly for locking, and the lock does not need to be unlocked before being locked, so that the operation is convenient.

In one embodiment, the snap hook assembly 221 includes a moving seat 2211 and a snap hook 2212. The moving seat 2211 is in sliding fit with the bottom of the housing 210, the snap hook 2212 is rotatably connected to the top of the moving seat 2211, and the snap hook 2212 is capable of being in hooking fit with the zipper tab 100 at the locking position and being separated from the zipper tab 100 at the unlocking position. The snap hook 2212 is enabled to be in hooking fit with the zipper tab 100 at the locking position, so that the zipper tab can still be inserted into the lock hole to be in fit with the snap hook assembly 221 for locking in the locking state without the lock being unlocked before being locked

Exemplarily in order to enable the zipper tab 100 to be in hooking fit with the snap hook 2212, the zipper tab 100 of the present application is provided with a snap ring 101 capable of hooking the snap hook 2212. The snap ring 101 is used to be hooked with the snap hook 2212, and the structure is simple.

In one embodiment, the lock hook mechanism 220 further includes a resilient piece 222 capable of abutting against the zipper tab 110. The resilient piece 222 is a spring leaf whose two ends can be respectively in contact with the two zipper tabs 100, and the resilient piece 222 is used to abut against the zipper tabs 100, so that the zipper tabs 100 can be quickly ejected during unlocking, and the zipper tabs 100 can be easily separated from the lock holes 211.

In one embodiment, a torsion spring is connected between the snap hook 2212 and the moving seat 2211. The snap hook 2212 can be resiliently rotated by utilizing the resilient force of the torsion spring, so that the snap hook 2212 can be quickly reset to an initial state after being rotated.

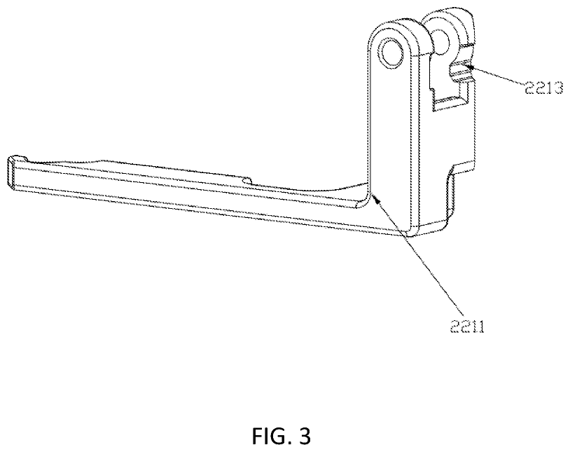

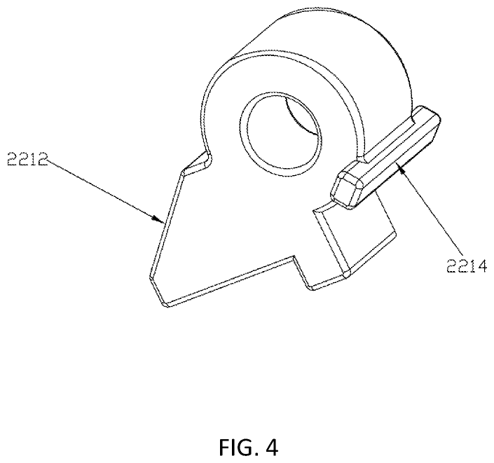

As shown in FIGS. 3 and 4, the moving seat 2211 is provided with a limit groove 2213 for limiting a rotation angle of the snap hook 2212, and the snap hook 2212 is provided with a limit portion 2214 for being in sliding fit with the limit groove 2213. The rotation angle of the snap hook 2212 is limited, so that the snap hook 2212 can be hooked with the zipper tab 100 after being rotated a preset angle. The snap hook 2212 is also rotated the preset angle in a resetting process, so that the zipper tab 100 is ensured to be stably hooked with the snap hook 2212 without slipping off.

In order for the snap hook assembly 221 to move merely between the locking position and the unlocking position, in the present application, the bottom of the housing 210 is provided with a limit block 212 for limiting the movement stroke of the moving seat 2211. The movement stroke of the moving seat 2211 is limited, so that the snap hook assembly 221 can be ensured to move accurately between the locking position and the unlocking position.

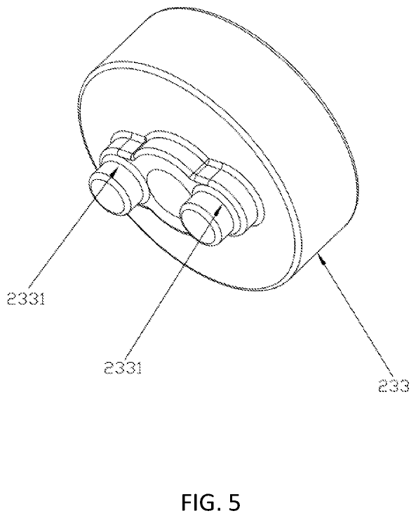

With regard to the drive mechanism 230 for driving the snap hook assembly 221 to move, in the present application, the drive mechanism 230 includes a lock core 231, a lock core barrel 232 and a drive disc 233. The lock core 231 is sleeved with the lock core barrel 232 and coaxially connected to the drive disc 233, and the lock core 231 is rotatable relative to the lock core barrel 232. A connection portion 2331 is disposed eccentrically on the drive disc 233, and the connection portion 2331 is connected to the moving seat 2211. As shown in FIG. 5, in the present application, two connection portions 2331 are disposed eccentrically on the drive disc 233, and the two connection portions 2331 are separately connected to the moving seat 2211. Thus, the moving seat 2211 can be driven to move simply when the lock core 231 is rotated, so that the snap hook assembly 221 is driven to move between the locking position and the unlocking position, and the operation is convenient. The two connection portions 2331 are symmetrical about the center line of the drive disc 233. When the lock core 231 is rotated, the two snap hook assemblies 221 will be close to each other or far away from each other, so that the two snap hook assemblies 221 can move between their respective locking positions and unlocking positions at the same time.

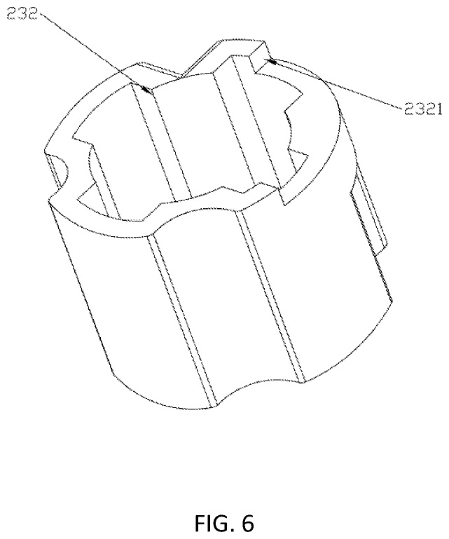

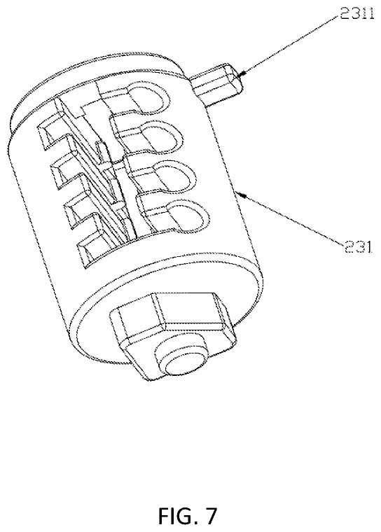

As shown in FIGS. 6 and 7, an end portion of the lock core barrel 232 is provided with a notch 2321 for limiting a rotation angle of the lock core 231, and the lock core 231 is provided with a bump 2311 for being in sliding fit with the notch 2321. The rotation angle of the lock core 213 is limited, so that the snap hook assembly 221 can be ensured to move accurately between the locking position and the unlocking position.

To facilitate the operation of the lock core 231, in the present application, a top of the housing 210 is provided with a through hole 213 for the top of the lock core 231 to protrude through. The through hole 213 is configured to expose the lock core 231, facilitating the operation of the lock core 231 or mounting of a button on the lock core 231.

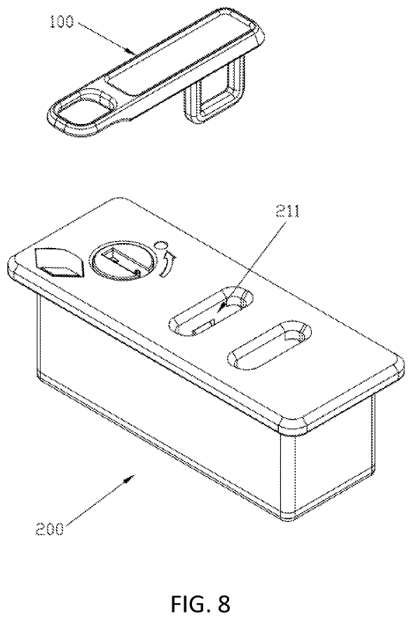

FIGS. 8 to 15 are operation views showing locking and unlocking of the luggage lock of the present application, and the operation processes of locking and unlocking of the luggage lock are described below.

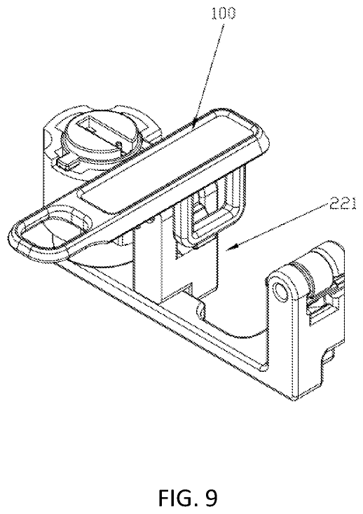

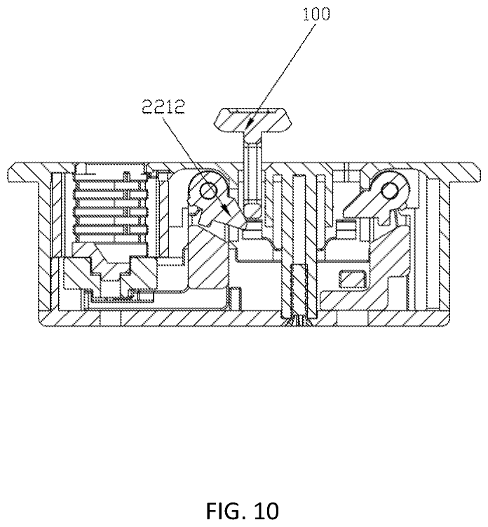

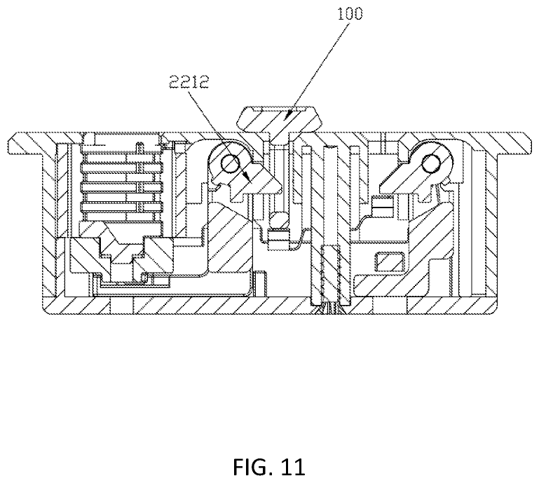

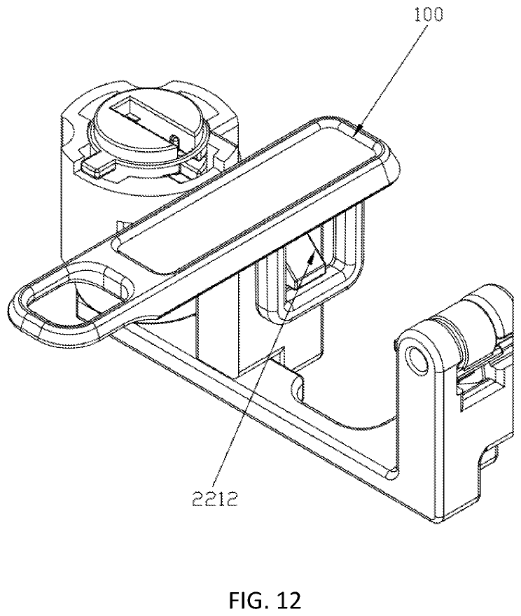

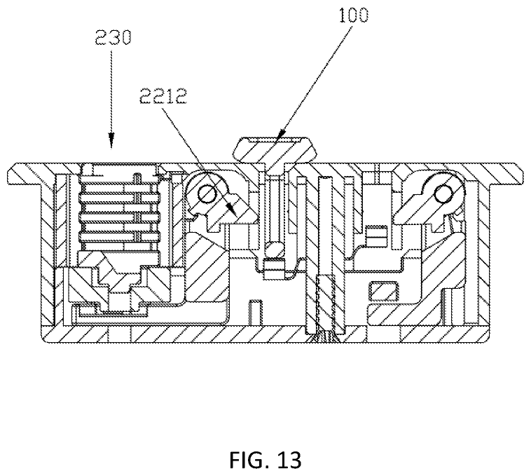

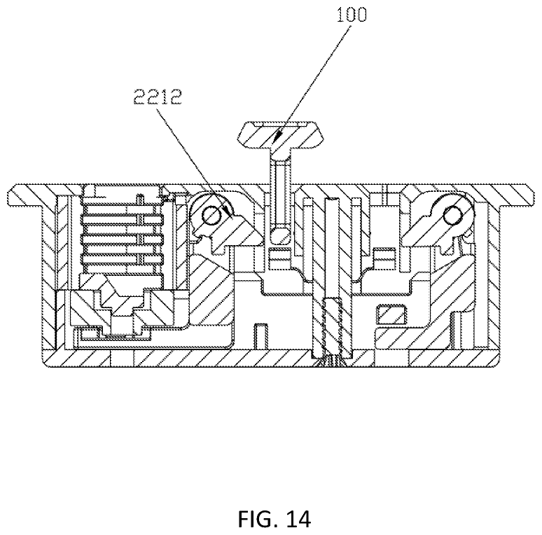

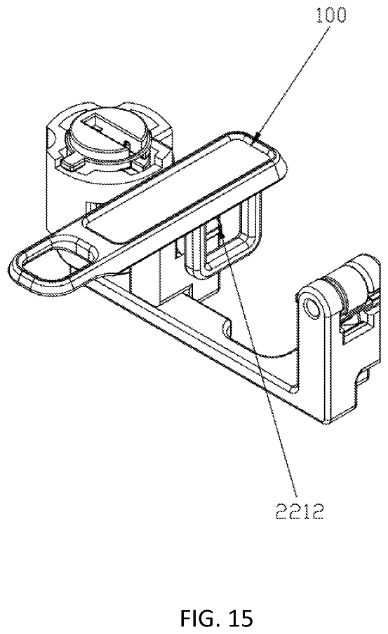

As shown in FIG. 8, in preparation for locking, the zipper tab 100 is aligned with the lock hole 211 of the lock body 200 and inserted into the lock hole 211. After the zipper tab 100 is inserted into the lock hole 211, as shown in FIGS. 9 and 10, the zipper tab 100 is brought into contact with the snap hook 2212 in the snap hook assembly 221, the snap hook 2212 is being rotated until the snap hook 2212 is in hooking fit with the zipper tab 100, and as shown in FIGS. 11 and 12, the locking is achieved. When the snap hook assembly 221 is at the locking position, if the zipper tab 100 is not hooked with the snap hook 2212, the zipper tab 100 can still be inserted into the lock hole 211 to be in contact with and in hooking fit with the snap hook 2212. In preparation for unlocking, as shown in FIG. 13, the hook assembly 221 is driven by the drive mechanism 230 to move, so that the snap hook 2212 is separated from the zipper tab 100, the zipper tab 100 is ejected, and the unlocking is achieved, as shown in FIGS. 14 and 15.

To sum up, the luggage lock provided by the present application is convenient to operate, and the zipper tab 100 can still be inserted into the lock hole 211 in the locking state.

1. A luggage lock, comprising a zipper tab and a lock body, wherein the lock body comprises:
a housing, wherein the housing is provided with at least one lock hole capable of being in fit with the zipper tab;
a lock hook mechanism disposed in the housing, wherein the lock hook mechanism comprises a snap hook assembly, the snap hook assembly is movable between a locking position and an unlocking position, the locking position is aligned with one of the at least one lock hole, and the unlocking position is located outside the one of the at least one lock hole; and
a drive mechanism disposed in the housing, wherein the drive mechanism is capable of driving the snap hook assembly to move between the locking position and the unlocking position,
wherein the snap hook assembly comprises:
a moving seat, wherein the moving seat is in sliding fit with a bottom of the housing; and
a snap hook, wherein the snap hook is rotatably connected to a top of the moving seat, and the snap hook is capable of being in hooking fit with the zipper tab at the locking position and being separated from the zipper tab at the unlocking position.

2. (canceled)

3. The luggage lock according to claim 1, wherein the lock hook mechanism further comprises a resilient piece capable of abutting against the zipper tab.

4. The luggage lock according to claim 1, wherein a torsion spring is connected between the snap hook and the moving seat.

5. The luggage lock according to claim 3, wherein the moving seat is provided with a limit groove for limiting a rotation angle of the snap hook, and the snap hook is provided with a limit portion for being in sliding fit with the limit groove.

6. The luggage lock according to claim 1, wherein the bottom of the housing is provided with a limit block for limiting a movement stroke of the moving seat.

7. The luggage lock according to claim 1, wherein the drive mechanism comprises a lock core, a lock core barrel and a drive disc, wherein:
the lock core is sleeved with the lock core barrel and coaxially connected to the drive disc, and the lock core is rotatable relative to the lock core barrel; and
a connection portion is disposed eccentrically on the drive disc, and the connection portion is connected to the moving seat.

8. The luggage lock according to claim 7, wherein an end portion of the lock core barrel is provided with a notch for limiting a rotation angle of the lock core, and the lock core is provided with a bump for being in sliding fit with the notch.

9. The luggage lock according to claim 7, wherein a top of the housing is provided with a through hole for a top of the lock core to protrude through.

10. The luggage lock according to claim 1, wherein the zipper tab is provided with a snap ring capable of hooking the snap hook.

11. The luggage lock according to claim 4, wherein the moving seat is provided with a limit groove for limiting a rotation angle of the snap hook, and the snap hook is provided with a limit portion for being in sliding fit with the limit groove.
